(19) United States
(12) Patent Application Publication
(10) Pub. No.: US 2010/0286815 A1
(43) Pub. Date: Nov. 11, 2010

(54) METHOD AND APPARATUS FOR SORTING DIFFERENT KINDS OF ARTICLES

(75) Inventor: Armin Zimmermann, Konstanz (DE)

Correspondence Address: LERNER GREENBERG STEMER LLP, P O BOX 2480, HOLLYWOOD, FL, 33022-2480, US

(73) Assignee: Siemens Aktiengesellschaft, Munchen (DE)

(21) Appl. No.: 12/777,422

(22) Filed: May 11, 2010

(30) Foreign Application Priority Data
May 11, 2009 (DE) 10 1009 020 664.7

(51) Int. Cl. B07C 5/00; G06F 7/00

(52) U.S. Cl. 700/223

(57) ABSTRACT

A method and an apparatus sort different kinds of articles, in particular flat mail items, according to a prescribed feature. At least one sequence of articles is formed such that each sequence contains a series of subsequences, all the articles in a subsequence have the same feature value, and the order of the subsequences in the sequence corresponds to the prescribed order of feature values. A plurality of insertion steps involve at least one respective article being inserted into a sequence. At least one sequence has a plurality of separating elements inserted into it. A pair of separating elements separates one subsequence from an adjacent subsequence. Each insertion step contains the steps that a pair of separating elements is ascertained which adjoins the subsequence and separates the subsequence from an adjoining subsequence, and that the article is inserted between two separating elements in the ascertained pair of separating elements.

### CROSS-REFERENCE TO RELATED APPLICATION

This application claims the priority, under 35 U.S.C.§119, of German application DE 10 2009 020 664.7, filed May 11, 2009; the prior application is herewith incorporated by reference in its entirety.

### BACKGROUND OF THE INVENTION

### Field of the Invention

The invention relates to a method and an apparatus for sorting different kinds of articles, in particular flat mail items, according to a prescribed feature.

German patent DE 10 2006 029 723 B3 describes a method and an apparatus for combining large mail items with relatively small mal items. The large mail items can be processed manually, and the relatively small mail items have previously been put into an order by a sorting installation. The respective destination address of each relatively small mail item has been ascertained, and the relatively small mail items have been automatically sorted in line with a sequence among the possible destination addresses. Following the sorting, a plurality of areas of ail terns are formed for a respective section of the sequence. This series of pre-sorted relatively small mail items has the larger mail items inserted into it at the respective correct position. To make it easier for the large mail items to be sorted in, separating cards are sorted together with the relatively small mail items, e.g. one separating card per route section. The separating card indicates the start of the route section.

U.S. patent publication 20060283784 A1 proposes pre-sorting mail Items or other articles, e.g. into different article classes which are defined by the dimensions of the mail items. A sorting installation for the first class (“letters” that is to say standard letters) sorts the mail items in this class in line with a prescribed order of destinations. The mail items in the second class (“flats”, that is to say large letters) are likewise sorted and in so doing mixed with the mail items in the first class. In one embodiment, the mail items in the first class are sorted into two sorting passes (“two-pass sorting”). For the mail items in the second class, a first sorting pass is performed. In a second sorting pass, sorted substacks of standard letters are mixed with the large letters. This involves the substacks being channeled in between a stream of large letters.

European patent EP 1093402 B1 describes a method and an apparatus for combining a plurality of stacks of mail items to form an overall stack. The mail items in each stack have already been sorted in line with the destination details on the mail items and a prescribed order among destinations prior to combination. The overall stack is formed by virtue of the mail items being deposited on a transportation section in line with a particular procedure.

In German patent DE 10342804 B3, corresponding to U.S. Pat. No. 7,201,277, mail items from various stacks are likewise combined to form an overall stack per destination. The overall stacks are formed on a conveyor belt which is divided into sections, each section being associated with a destination. First of all, relatively large mail items are distributed over the sections in line with the destinations of the mail items, such that the mail items lie horizontally in the respective section on the conveyor belt. Above the conveyor belt, there is a transportation track with containers which are moved relative to the conveyor belt. Relatively small mail items for a destination are located in the respective container. The container is moved over the respective section and emptied there.

U.S. Pat. No. 5,347,790 describes an “automatic sweeping device” for mail items. The apparatus has three separating elements (“plates 35, 36, 37”). The separating elements 35, 36, 37 can be moved to and fro in linear fashion. In an engagement position, a separating element engages in a stack of mail items from the side. The stack contains mail items which stand upright on a base. The stack can be moved past a separating element in a release position. The apparatus takes a substack of the stack into a container which is stationary beneath the base. The substack falls through an opening, which is opened at the correct time, from the top into the container, To this end, a dividing element enters the stack and thereby produces a substack. The separating element is moved toward a second separating element, so that these two separating elements define the substack and compress it between them and, as a result of their movement, take the substack above the opening. Two door wings in the opening are briefly opened, so that the substack can drop down.

### SUMMARY OF THE INVENTION

It is accordingly an object of the invention to provide a method and an apparatus for sorting different kinds of articles which overcome the above-mentioned disadvantages of the prior art methods and devices of this general type, which prevent a flat article from being damaged during insertion.

With the foregoing and other objects in view there is provided, in accordance with the invention a method for sorting articles according to a prescribed feature, wherein an order of feature values is prescribed among possible values of the prescribed feature. The method includes the steps of taking a measurement for each article to determine what value the prescribed feature assumes for the article, and forming at least one sequence of articles such that each sequence contains a series of subsequences. All of the articles in a subsequence have a same feature value, and an order of the subsequences in the sequence corresponds to a prescribed order of feature values. The insertion step is repeatedly performed. The insertion step involves at least one respective article being inserted into a sequence such that a subsequence in the sequence, the articles in which all have the same feature value as the article to be inserted, is complemented by the article to be inserted, and insertion steps are performed until each article to be sorted has been inserted into a sequence. A plurality of separating elements is inserted into at least one sequence which contains three different subsequences. At least one automatic handling machine is provided for inserting the separating elements. The at least one sequence is produced such that each of the subsequences inside the sequence adjoins a pair of at least two separating elements, so that one separating element in the pair of separating elements directly adjoins the at least one subsequence. The pair of separating elements separates the at least one subsequence from an adjacent subsequence in the sequence, and following an insertion step there is no article located between the separating elements in the pair of separating elements. Each insertion step, in which the at least one subsequence inside the sequence is complemented by an article is performed by the further steps of: ascertaining the pair of separating elements which adjoins the at least one subsequence and separates the at least one subsequence from an adjoining subsequence; and inserting, via the automatic handling machine, the article between two separating elements in the ascertained pair of separating elements.

The method based on the solution and the apparatus based on the solution are configured to sort articles according to a prescribed feature.

The feature which is to be used for sorting is prescribed. The range of values for the feature contains discrete values or is broken down into discrete values. An order of feature values is prescribed among these possible values of the sorting feature.

A plurality of separating elements and an automatic handling machine are used.

A measurement is taken for each article to be sorted to determine what value the feature assumes for the article.

At least one sequence, that is to say a series of articles, is formed. The at least one sequence is formed such that each sequence contains a series of subsequences, all the articles in a subsequence have the same feature value, and the order of the subsequences in the sequence corresponds to the prescribed order of feature values.

If a sequence contains three different subsequences, at least one subsequence is located inside the sequence, i.e. this subsequence is bounded on both sides by a respective different subsequence. The automatic handling machine inserts a plurality of separating elements into at least one sequence containing three different subsequences. The subsequences in the sequence are produced using the separating elements such that the following effect is achieved. Each subsequence inside the sequence adjoins a pair containing at least two separating elements, so that one separating element in the pair of separating elements directly adjoins the subsequence. The pair of separating elements separates the subsequence from an adjacent subsequence in the sequence.

In order to insert further articles into this sequence of articles which has already been formed, an insertion step is repeatedly performed. Each insertion step involves the automatic handling machine inserting at least one respective article into a sequence. In this context, the automatic handling machine inserts the article into the sequence such that a subsequence in the sequence, the articles of which all have the same feature value as the article to be inserted, is complemented by the article to be inserted.

The insertion step is performed such that following the insertion step there is no article located between the separating elements in the pair of separating elements.

If the effect of the insertion step is that a subsequence inside a sequence is complemented by an article, then this insertion step includes the now described steps. A pair of separating elements is ascertained which adjoins the subsequence and separates the subsequence from an adjoining subsequence. The automatic handling machine inserts the article between two separating elements in the ascertained pair of separating elements.

These insertion steps are performed until each article to be sorted has been inserted into a sequence.

The separating elements prevent an article from having to be inserted directly between two other articles which have already been sorted. Such direct insertion could bend an article or damage it in another way. Furthermore, articles could stick to one another. On the contrary, an article is inserted between two separating elements. A suitable design of the separating elements prevents damage.

The separating elements allow even flat flexible articles to be put into an order without damaging them, for example flat mail items, bank notes, groceries, books etc.

The invention allows an article to be inserted into the series of already sorted articles at a correct position, “correct” relating to the prescribed order of feature values. Each article is inserted at one end of a subsequence containing articles with the same feature values.

In one preferred refinement, at least one insertion step, in which a subsequence inside the sequence is complemented by an article, includes the following now described steps.

A pair of separating elements is ascertained which adjoins the subsequence and separates the subsequence from an adjoining subsequence.

The automatic handling machine inserts a further separating element between two separating elements in the ascertained pair of separating elements.

The article and also the further separating element are inserted by the automatic handling machine such that following the insertion of the article and the further separating element, the article is located between the further separating element and that separating element in the ascertained pair of separating elements which directly adjoins the subsequence, and the further separating element is located between two separating elements in the ascertained pair of separating elements.

Other features which are considered as characteristic for the invention are set forth in the appended claims.

Although the invention is illustrated and described herein as embodied in a method and an apparatus for sorting different kinds of articles, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, top view of a combining sorting installation in an exemplary embodiment according to the invention;

FIG. 2 is an illustration showing a stack in an output unit prior to the insertion of an additional mail item;

FIG. 3 is an illustration showing the stack from FIG. 2 with an inserted additional separating element;

FIG. 4 is an illustration showing a stack from FIG. 3 with an inserted additional mail item; and

FIG. 5 is an illustration showing the stack from FIG. 4 following the removal of a separating element.

### DETAILED DESCRIPTION OF THE INVENTION

In the exemplary embodiment, the flat articles to be sorted are mail items, that is to say standard letters, large letters, catalogs, postcards, etc. Each mail item extends in one article plane.

Each mail item to be sorted needs to be transported to a respective destination, All of these destinations are in a prescribed area, which is part of the catchment area of a sorting center, for example. In the exemplary embodiment, the area is divided into disjunct subareas, i.e. every possible destination belongs to precisely one subarea. Each subarea is associated with a mailman.

Each mail item is provided with details relating to the destination to which the mail item needs to be transported. In the exemplary embodiment, these destination details act as the feature values according to which the articles need to be sorted. It is naturally possible for there to be an advance provision (“endorsements”) and for the mail item to need to be transported in line with this advance provision.

For each subarea, a respective order of destinations is prescribed. Each order of destinations (“delivery sequence”) is prescribed by the sequence in which the mailman visits the destinations in his assigned subarea in order to deliver the mail items and post or hand them in at the respective destinations. The destination order is the prescribed order of feature values.

A sorting installation is intended to sort all the mail items for destination addresses in the area such that all the mail items are sorted in line with the order of destinations for the subareas, specifically for all formats of mail items. The mail items for a subarea need to be taken to one or more transportation containers after sorting and, having been sorted into the transportation containers, transported to the respective delivery post office, There, a mailman receives the mail items for his subarea. The mailman does not need to sort the mail items anymore because the mail items are located in the containers such that they are sorted in line with the sequence.

The mail items vary considerably in their dimensions. In the exemplary embodiment, a distinction is therefore drawn between at least two classes of mail items. A first class of mail items contains the standard letters, that is to say the mail items whose width, height and thickness is within prescribed value ranges. A second class contains any mail item with a dimension which is outside of the respective prescribed value range, that is to say long or thick mail items.

First of all, the mail items are split in line with their dimensions over the at least two prescribed classes. This preferably involves the use of a format separating device, e.g. a drum with lamellae of different width or a device with slots of different width. Such devices are known from German patents DE 10148226 C1, DE 10141375 C1 (corresponding to U.S. Pat. No. 7,111,742) and DE 10223349 B4 (corresponding to U.S. Pat. No. 7,070,180). It is also possible for a large deliverer to deliver mail items sorted into classes in advance, e.g. in order to save transportation charges.

In a subsequent first sorting pass, the mail items in one class are then sorted separately from the mail items in the other classes. A first sorting installation sorts the mail items in the first class, that is to say the standard letters. The first sorting installation is optimized for a high throughput and can therefore sort standard letters quickly. A second sorting installation sorts the mail items in the second class, that is to say the large letters, catalogs, etc. The second sorting installation is optimized to be able to process mall items of different dimensions quickly. Such sorting installations are known from international patent disclosures WO 2006100594 A, WO 2006100601 A1 and WO 2006100592 A1, for example. A single sorting installation for both classes of mail items would achieve a lower throughput than the two sorting installations which are optimized for their respective task. The first sorting pass is performed both by the first sorting installation and by the second sorting installation.

A third sorting installation, subsequently referred to as the “combining sorting installation”, sorts the mail items in both classes in a subsequent second sorting pass and sets up the prescribed order of destinations among these mail items. The combining sorting installation is responsible for the area to which the mail items are to be transported.

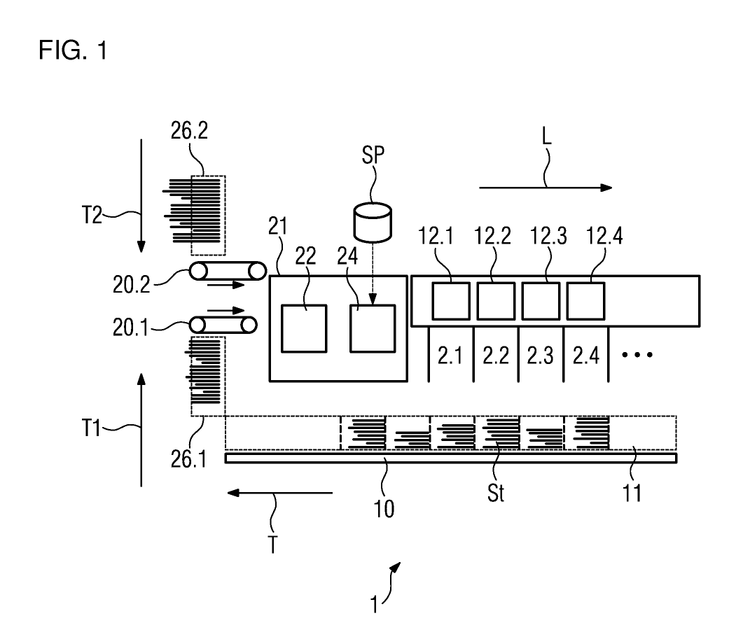

FIG. 1 schematically shows a top view of the combining sorting installation in the exemplary embodiment. This sorting installation contains the following components:
at least one respective supply device (“feeder”) having a singularizer 20.1, 20.2 per class of mail items:
a transportation device 21,
a reading device 22;
an output transfer apparatus 23;
an arrangement having a multiplicity of output devices 2.1, 2.2; . . .
a conveyor device 1 having a continuous conveyor belt 11;
a positioning device; and
a machine controller 24.

In the schematic illustration in FIG. 1, the singularizer 20.1 singularizes the standard letters and the singularizer 20.2 singularizes the large letters.

Each supply device for a class is configured for stacks of mail items in this class to be successively supplied to the supply device and for the supply device to singularize the supplied mail items, so that a stream of mail items in one class which are spaced apart from one another is formed. The supply device for the first class of mail items (standard letters) has a higher throughput in the exemplary embodiment than the supply device for the second class (large letters). For that reason, it is usually necessary to sort significantly more standard letters than large letters.

In the example in FIG. 1, the continuous conveyor belt 26.1 transports standard letters to the singularizer 20.1, and the continuous conveyor belt 26.2 transports large letters to the singularizer 20.2.

The transportation device 21 transports the series of mail items which are spaced apart from one another and upright through the sorting installation. Preferably, the transportation device 21 contains a system containing a plurality of vertically arranged continuous conveyor belts, two of which respectively clamp a mail item between them intermittently. It is possible for a mail item to be turned by two conveyor belts.

During transportation, the mail items pass through the reading device 22. The reading device 22 produces a respective digital image of that side of a mail item which holds the details relating to the delivery address. The reading device 22 evaluates the image and first of all attempts to automatically decipher the delivery address, e.g. by “optical character recognition” (OCR) or by means of “bar code reading”. If this is unsuccessful, the image is shown on a screen of a video encoding station. An operative reads the delivery address and inputs it into a keyboard or the like.

The machine controller 24 evaluates a sorting plan SP which is available to a computer. This sorting plan SP allocates a respective output device to every possible delivery address for a mail item. As a result, the sorting plan SP stipulates which mail items with which delivery addresses need to be transferred out to which output device. In the exemplary embodiment, there are substantially more possible delivery addresses than output devices, which means that the sorting plan SP usually allocates a plurality of delivery addresses to one output device 2.1, 2.2, . . . It is possible for the sorting plan SP to reserve individual output devices for only a single delivery address in each case, because a large number of mail items are being sent to this delivery address.

The transportation device 21 transports the mail item onward to the outward transfer apparatus 23. The outward transfer apparatus 23 preferably contains a series of separating filters, namely at least one respective separating filter per output device 2.1, 2.2, . . . A respective outward transfer path connects the transportation path to the output device. The separating filter either deflects a mail item into the outward transfer path or leaves the mail item in the transportation path.

The actual transportation speed of each transportation path is measured. The machine controller 24 therefore “knows” at what time each mail item is located at what position in the transportation device 21. Furthermore, the machine controller 24 “knows” the respective delivery address of each mail item after the reading device 22 has deciphered the delivery address. The machine controller 24 actuates that separating filter which connects the transportation path to that outward transfer path which is routed to that output device to which the mail item needs to be transferred out in line with the delivery address which has been read and the sorting plan SP. The mail item is transferred out from the transportation path by the separating filter and is transported on the outward transfer path to the output device.

The multiplicity of output devices 2.1, 2.2, . . . are—as seen in a longitudinal direction L—arranged in succession. In the exemplary embodiment, the longitudinal direction L points away from the supply device. It is possible for the output devices 2.1, 2,2, . . . to be mounted in a plurality of rows and for the rows to be arranged vertically or obliquely above one another. Each row extends in the longitudinal direction L.

The conveyor device 1 also extends in the longitudinal direction L. The continuous conveyor belt 11 transports mail items from the output units 2.1, 2.2, . . . either in the transportation direction T to the continuous conveyor belt 26.1, so that the mail items can pass through the combining sorting installation again in a second sorting path, or in the opposite direction. A supporting device 10 prevents mail items from being able to fall from the conveyor belt 11.

In one embodiment, each output unit contains a contact face and a coupling point for intermittently coupling a respective transportation container. A transportation container is connected to the output unit in a defined position, is automatically filled with sorted mail items by the sorting installation and is separated from the output unit again after filling and transported away.

In another embodiment, each output unit respectively contains a sorting compartment for mail items and a contact face for at least one transportation container. The sorting installation transfers out the mail items for a transportation container into the sorting compartment of the output unit. When all the mail items have been sorted, the sorted mail items are taken from a respective sorting compartment to a transportation container, the transportation container being stationary on the contact face, and are transported away in the transportation container.

In both refinements, a respective stack of flat and upright mail items is formed in or on each output unit. All the article planes of the mail items in this stack are approximately at right angles to a stack direction in which the stack extends.

In one embodiment, the bottom of the output unit is inclined. This also inclines a transportation container which is stationary in the output unit. The effect achieved by this refinement is that the flat and upright mail items in the output unit are oriented to a side wall or edge of the output unit and to the bottom, that is to say to two planes. The direction in which the bottom of the output unit is inclined is perpendicular to the stack direction in one refinement. Viewed in the stack direction, the bottoms of adjacent output units form a sawtooth line.

In another embodiment, a supporting element compresses the stack. The growing stack pushes the supporting element counter to the force of a spring. The two “inclined bottom” and “supporting element” embodiments can be combined.

Preferably, the output units are arranged in one or more rows, so that at least one output unit order is formed, Each row contains a number of output units situated next to one another. Preferably, a plurality of rows of output units are situated vertically or obliquely above one another.

The combining sorting installation applies a sorting plan which is available to a computer. The sorting plan allocates a respective output unit to every possible destination in the area. Because there are far more possible destinations than output units, the sorting plan respectively allocates the same output unit to a plurality of possible destinations. Preferably, the sorting plan ensures that the prescribed order of destinations corresponds to the order of output units. This means that the sorting plan either allocates the same output unit or allocates two directly adjacent output units to two possible destinations which are directly successive in the same order of destinations.

Furthermore, each output unit respectively has a guide element and a plurality of moving separating elements.

In one refinement, each separating element has a separating face and a connecting element. The connecting element connects the separating face to the guide unit. By way of example, the separating element is in the shape of a paddle and has a smooth surface, so that a mail item can slide along the separating face with low friction. The separating face is preferably so rigid that the insertion of a mail item does not bend the separating face.

The guide element is mounted on one side of the output unit. The stack of the mail items is situated next to the guide element, e.g. obliquely above the guide element. Each separating element can be moved in and opposite to the stack direction by a linear movement. The guide element ensures that the separating element is only able to perform linear movements along a section which is bounded on both sides. The separating face extends approximately parallel to the article planes of the flat mail items in the stack.

Furthermore, each separating element can be rotated about an axis of rotation which runs parallel to the stack direction. This allows the separating element to swing to and fro between an engagement position, in which the separating element engages in a stack in the output unit, and a release position, in which the separating element does not engage in the stack. It is also possible for each or at least some of the separating elements to be able to swing to and fro between the engagement position and the release position by a vertical linear movement.

In another refinement, each separating element only contains a flat separating face which is not connected to the output unit.

Furthermore, the combining sorting installation has at least one automatic handling machine, e.g. a robot. The automatic handling machine is able to insert a mail item between two mail Items in a stack in an output unit, specifically into each position in the stack. Each output unit in the combining sorting installation can be reached by at least one automatic handling machine, specifically at each position in a stack containing mall Items in the output unit. A respective one of the automatic handling machines is also able to position a separating element at any desired position of each output unit. By way of example, the automatic handling machine takes the separating element into the release position, moves the separating element along the guide element and takes the separating element at the desired position into the engagement position. Alternatively, the automatic handling machine takes the separating element from a stock of currently unused separating elements and positions the separating element at the desired position. It is possible for an automatic handling machine to be able to reach a plurality of output units.

In the exemplary embodiment, the combining sorting Installation has a respective automatic handling machine per output unit. FIG. 1 schematically shows four automatic handling machines 12.1, 12.2, 12.3 and 12.4 which are associated with the four output units 2.1, 2.2, 2.3 and 2.4. In the subsequent figures, the automatic handling machine 2.2 is shown schematically. Each automatic handling machine 2.1, 2.2, . . . is able to insert a separating element and also a further mail item in a stack in the associated output unit 2.1. 2.2, . . . and to remove the separating element from the stack again.

Each output unit also has an associated buffer store. The transportation device takes each mail item from the respective supply device via a transportation path to the buffer store in that output unit into which the mail item needs to be transferred out. If the buffer store is full, the transportation device takes the mail item to another buffer store which is currently free, e.g. to the buffer store in an adjacent output unit.

The buffer store is able to hold a mail item, specifically including the largest possible mail item. It is not necessary for the buffer store to be able to hold a plurality of mail items. By way of example, the buffer store is a pocket or a narrow compartment into which a mall item is placed, or a face onto which the mail item is laid, or a clamp which intermittently grips the mail item. Preferably, the buffer store contains a sensor which establishes and reports whether or not there is currently a mail item in the buffer store.

As already mentioned, the two classes of mail items are sorted separately from one another in the first sorting pass, namely the mail items in the first class are sorted by the first sorting installation and those in the second class are sorted by the second sorting installation. Next, a stream of mail items for the area reaches the combining sorting installation. By way of example, the ail items in the first class for the area (the standard letters) reach the combining sorting installation first and then the mail items in the second class (the large letters), or vice versa. It is also possible for mail items in both classes to reach the combining sorting installation in a mixed order.

Each mail item passes through the combining sorting installation. The combining sorting installation establishes the destination to which the mail item needs to be transported. For this purpose, the combining sorting installation either reads a machine-readable coding, e.g. a bar code, on the mail item, or the combining sorting installation applies a “fingerprint” method in order to recognize the mail item from a feature vector and in order to recover the destination details already read and stored. Such methods are described in German patent DE 4000603 C2, European patent EP 1222037 B1 and international patent disclosure WO 2008059017 A1, for example.

The combining sorting installation evaluates the sorting plan, establishes which output unit is associated with the destination for the mail item, and thereby ascertains the output unit to which the mail item needs to be transferred out. A transportation device in the combining sorting installation transports the mail item to the buffer store in the ascertained output unit.

This additional mail it M now needs to be inserted into the tack of mail items which is already in the output unit, specifically at the correct position, that is to say at the position which is stipulated by the destination address of the additional mail item and also by the prescribed order of destinations. The mail items in the stack have already been sorted in line with the order of destinations and may contain mail items of all classes. Those mail items in the stack which need to be transported to the same destination form a substack in the stack. The stack thus contains a series of substacks. It does not matter in what order the mail items for the same destination are sorted into the substack or are located in the substack.

In one preferred refinement, the stack contains a sequence of two respective separating elements in the engagement position, then two substacks containing mail items, then two further separating elements in the engagement position, then two further substacks containing mail items, and so on. The substacks have already been sorted in line with the order of destinations. Because two fewer separating elements in total engage in the stack than there are substacks, separating elements are saved in comparison with an embodiment in which a respective separating element is always provided between two separating elements. This saves separating elements and also space in the stack direction.

The separating elements are preferably homogeneous. In one refinement, each separating element is provided with a machine-readable identifier. In another refinement, the separating elements are indistinguishable.

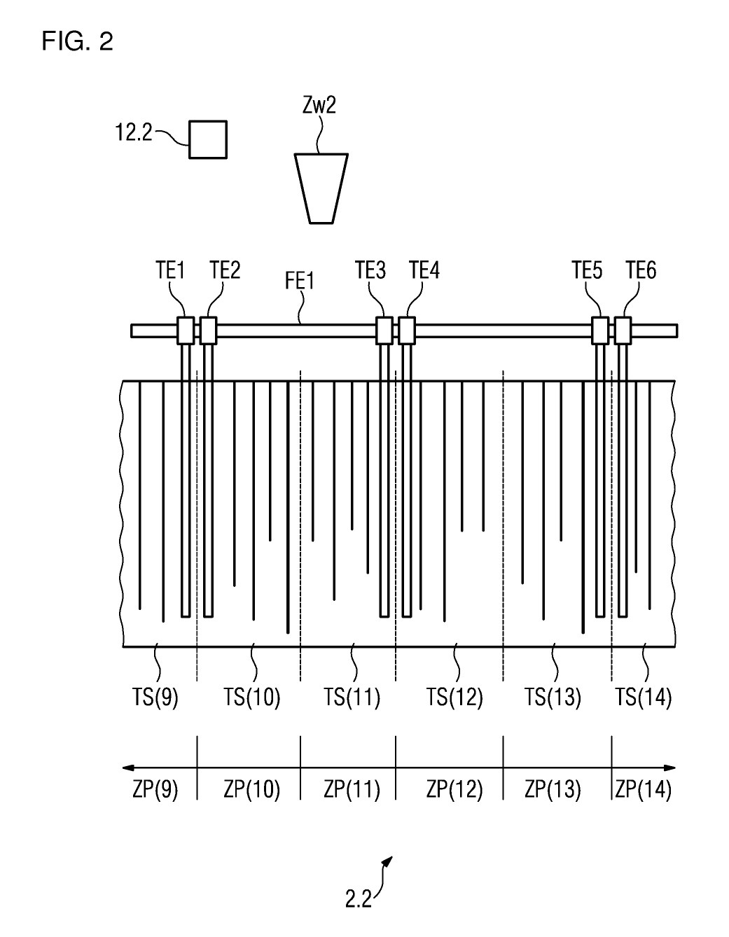

FIG. 2 shows an example of a stack in an output unit 2.2 prior to the insertion of an additional mail item Ps. The figure shows the detail from the stack, which contains the substacks TS(9) to TS(14) for the destinations ZP(9) to ZP(14). The substack TS(i) contains all the mail items which have been transferred out to the output unit 2.2 to date and which need to be transported to the destination ZP(i) (i=1, 2, . . . ). The order of destinations stipulates the following order: first ZP(1), then ZP(2), then ZP(3) and so on. In addition, FIG. 2 indicates the buffer store Zw2 of the output unit 2.2.

In addition, six separating elements TE1, . . . TE6 are shown which are guided by a guide element FE1. The separating elements TE1 and TE2 separate the mail items in the substacks TS(9) and TS(10) from one another, and the separating elements TE3 and TE4 separate the mail items in the substacks TS(11) and TS(12), and the separating elements TE6 and TE6 separate the mail items in the substacks TS(13) and TS(14). To clarify, the boundaries between the substacks TS(9), TS(10), . . . are indicated by dashed lines. The substacks TS(10) and TS(11), the substacks TS(12) and TS(13) and also the substacks TS(14) and TS(15) have no separating elements or other separations between them.

The combining sorting installation has stored the information regarding which mail items have already been transferred out to the output unit 2.2 and regarding the substacks in which they are located. Furthermore, the combining sorting installation has stored which substacks are separated from one another by two respective separating elements and which are not. If the separating elements are provided with machine-readable identifiers, the combining sorting installation has stored which separating element is located between which substacks. Otherwise, the combining sorting installation has shared which substacks (i.e. substacks for which destinations) are separated by separating elements.

It is now necessary to transfer out an additional item Ps and to insert it into the stack. The combining sorting installation has established that this mail item Ps needs to be transported to the destination ZP(10) and therefore the substack TS(10) needs to be complemented by the mail item Ps. By evaluating the sorting plan, the combining sorting installation establishes that the destination ZP(10) has the output unit 2.2 associated with it. Therefore, the combining sorting installation transports the additional mail item Ps to the buffer store Zw2 of the output unit 2.2.

The automatic handling machine automatically establishes that the substack TS(10) is located between the pair of separating elements containing the separating elements TE2 and TE3 and adjoins the separating element TE2. The separating element TE2 is adjoined by the separating element TE1. The automatic handling machine establishes this by evaluating the information about substacks and separating elements which the combining sorting installation has ascertained and stored as described above. If the separating elements are provided with machine-readable identifiers, a reader in the automatic handling machine evaluates the identifiers. Otherwise, a reader counts the separating elements starting with the first separating element in the output unit 2.2 in order to find the pair of separating elements which is adjoined by the substack TS(10).

The additional mail item Ps is intended to complement the substack TS(10). The additional mail item Ps is therefore inserted between the two separating elements TE1 and TE2.

In one refinement, the separating element TE2 is then moved, namely pushed in between the additional mail item Ps and the separating element TE1.

In one preferred refinement, the separating element TE2 is prevented from damaging the additional mail item Ps or another mail item when inserted.

The output unit 2.2 has at least one additional separating element TE7. This additional separating element TE7 may currently be in a release position and located in a separate parking position. Alternatively, the additional separating element TE7 is in an engagement position and located at that position in the stack in the output unit 2.2 at which the automatic handling machine has previously inserted the additional separating element TE7.

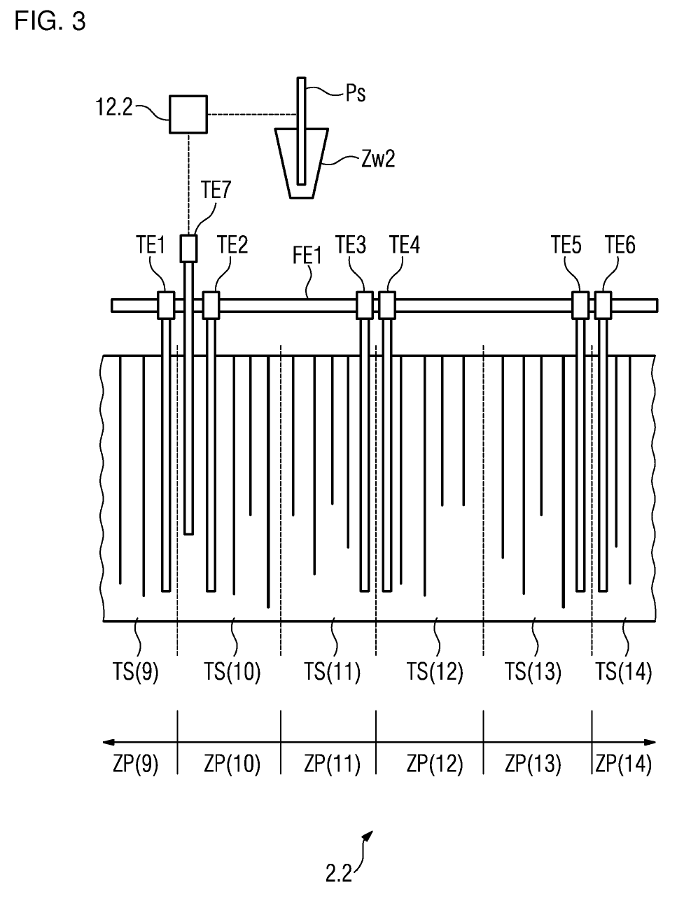

In the preferred refinement, the automatic handling machine first of all positions the additional separating element TE7 in the stack in an engagement position such that the additional separating element TE7 is located between the two separating elements TE1 and TE2. During insertion, the additional separating element TE7 does not come into contact with mail items. This contact is prevented by the two separating elements TE1 and TE2. As a result, the two substacks TS(9) and TS(10) now have the separating elements TE1, TE7 and TE3 located between them. This situation is shown by FIG. 3.

The additional mail item Ps is inserted between two of these three separating elements TE1, TE7 and TE2. The additional mail item Ps is intended to complement the substack TS(10). Therefore, the additional mail item Ps is inserted between the separating element TE2, which adjoins the target substack TS(10) for the destination ZP(10) of the additional mail item Ps, and the separating element TE7, which adjoins the separating element TE2.

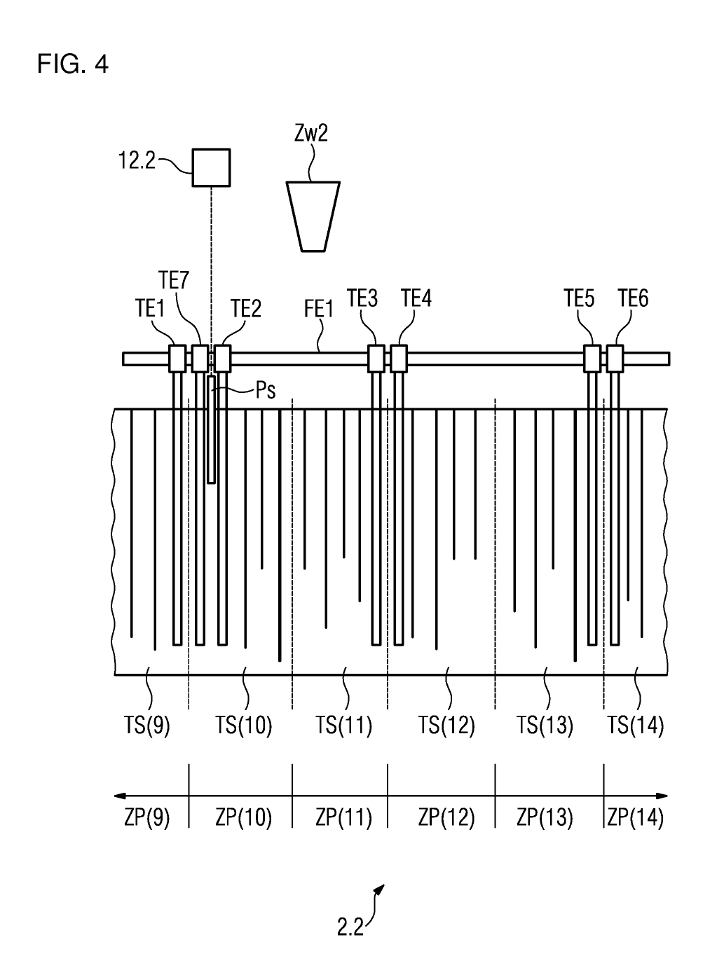

The automatic handling machine grips the mail item Ps to be inserted from the buffer store Zw2 in the output unit 2.2 and inserts the mail item Ps between the separating elements TE2 and TE7. The situation following this insertion is shown by FIG. 4. Because the automatic handling machine inserts a mail item between the two separating faces of the separating elements TE2 and TE7, there is no possibility of the inserted mail item Ps or a mail item which is already in the stack being bent or otherwise damaged by the insertion process or of the mail item Ps sticking to another mail item. This advantage is attained regardless of the size of the mail item Ps.

The automatic handling machine concludes the insertion of the mail item Ps into the stack. Subsequently, the separating element TE2 is no longer required in order to insert the mail item Ps. The separating element TE2 now acts as the additional separating element of the output unit 2.2, that is to say performs the function which the separating element TE7 previously performed.

In one embodiment, the separating element TE2 remains in the stack at this position and in the engagement position until a further mail item needs to be inserted into the stack or the sorting has been concluded.

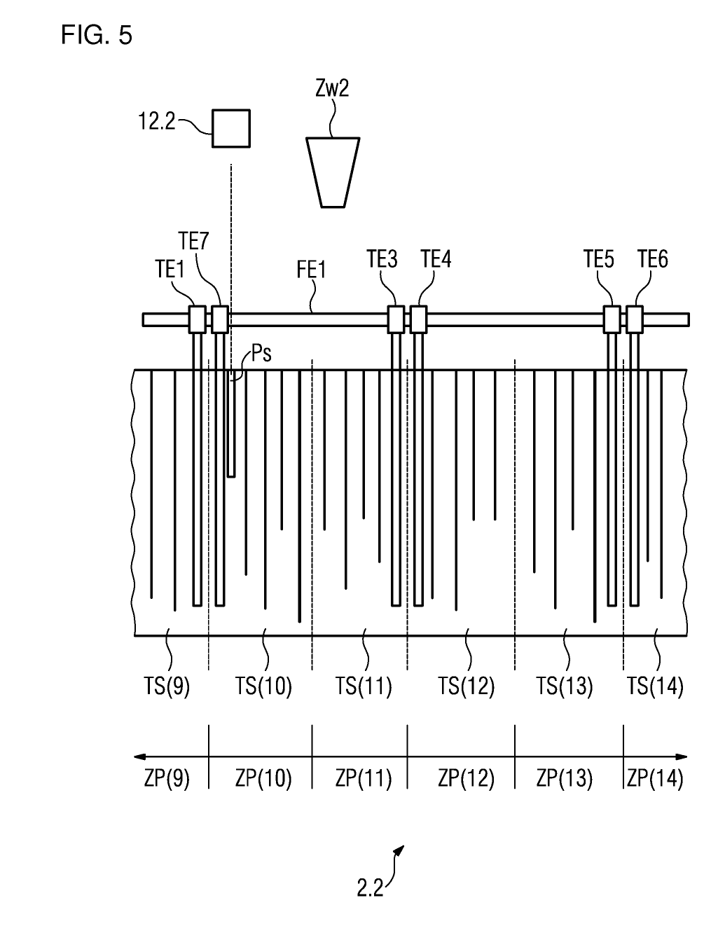

In another embodiment, the automatic handling machine removes the separating element TE2 from the stack, for example by virtue of the automatic handling machine transferring the separating element TE2 immediately from the engagement position to the release position. FIG. 5 shows the situation following the removal of the separating element TE2. If required, the separating elements push together the stack in the output unit 2.2 and therefore dose the gap which has been produced by the removal of the separating element TE2.

Preferably, the output unit 2.2 has a restraining element. The restraining element prevents a mal item from being pulled out of the stack in the output unit when the automatic handling machine removes the separating dement TE2 from the stack. By way of example, the restraining dement is in the form of a restraining edge or else as a bar. The automatic handing machine inserts a mail item into the stack, with the automatic handling machine guiding the mail item around the restraining element.

In the exemplary embodiment just described, the buffer store Zw2 of the output unit 2.2 was used in order to buffer-store the additional mail item Ps. When the mail item Ps has been inserted into the stack, the buffer store Zw2 is available for further mail items again. The sensor of the buffer store Zw2 reports to the combining sorting installation whether the buffer store Zw2 is currently occupied or free.

If the buffer store Zw2 is not available, e.g. because a further mail item needs to be transferred out to the output unit 2.2 immediately after the mail item Ps, then the combining sorting installation uses either a free buffer store in an adjacent output unit or a special overflow buffer store. The automatic handing machine is able to act over a plurality of output units and therefore to remove a mail item from one of a plurality of attainable buffer stores selectively.

The output unit 2.2 preferably has a filling level sensor. It is possible for the combining sorting installation to establish that the output unit 2.2 has reached a prescribed filling level and is unable to hold any further mail items. This is established by the combining sorting installation either on the basis of a report from the filling level sensor or by virtue of it counting the number of mail items which the combining sorting installation has transferred out to the output unit 2.2 to date, or measuring and adding the thicknesses of these mail items. If a further mail item then “actually” needs to be transferred out to the output unit 2.2, the steps described below are preferably performed.

The combining sorting installation modifies the prescribed sorting plan. The changed sorting plan no longer allocates the completely full output unit 2.2 to two destinations ZP(n) and ZP(n+1), but rather another, less full output unit 2.x. These two destinations ZP(n) and ZP(n+1) are selected such that they succeed one another directly in the order of destinations and the two substacks TS(n) and TS(n+1) for these two selected destinations are located between two separating elements.

The automatic handling machine removes the two substacks TS(n) and TS(n+1) from the full output unit 2.2. In this case, the automatic handling machine inserts a gripping hand or a similar gripping element into the stack between the two separating elements and the two substacks TS(n) and TS(n+1). The gripping element grips the two substacks TS(n) and TS(n+1), removes them from the output unit 2.2 and inserts them into the less full output unit 2.x.

As soon as all the mail items for the area have been sorted and have been distributed over the output units, the separating elements TE1, TE2, . . . are no longer required. The automatic handling machine removes the separating elements, for example by virtue of it transferring all the separating elements from the engagement position into the release position. Each output unit now contains a respective stack containing mail items which have been sorted in line with the prescribed order of destinations. The restraining elements prevent a mail item from being unintentionally removed from an output unit when the separating elements TE1, TE2, . . . are removed.

1. A method for sorting articles according to a prescribed feature, wherein an order of feature values is prescribed among possible values of the prescribed feature, which comprises the steps of:
taking a measurement for each article to determine what value the prescribed feature assumes for the article;
forming at least one sequence of articles such that each sequence contains a series of subsequences, all of the articles in a subsequence have a same feature value, and an order of the subsequences in the sequence corresponds to a prescribed order of feature values;
repeatedly performing an insertion step, the insertion step involves at least one respective article being inserted into a sequence such that a subsequence in the sequence, the articles in which all have the same feature value as the article to be inserted, is complemented by the article to be inserted, and insertion steps are performed until each article to be sorted has been inserted into a sequence;
inserting a plurality of separating elements into at least one sequence which contains three different subsequences;
providing at least one automatic handling machine for inserting the separating elements; and
producing the at least one sequence such that each of the subsequences inside the sequence adjoins a pair of at least two separating elements, so that one separating element in the pair of separating elements directly adjoins the at least one subsequence, the pair of separating elements separates the at least one subsequence from an adjacent subsequence in the sequence, and following an insertion step there is no article located between the separating elements in the pair of separating elements;
performing each insertion step, in which the at least one subsequence inside the sequence is complemented by an article with the further steps of:
ascertaining the pair of separating elements which adjoins the at least one subsequence and separates the at least one subsequence from an adjoining subsequence; and
inserting, via the automatic handling machine, the article between two separating elements in the ascertained pair of separating elements.

2. The method according to claim 1, which further comprises performing the insertion step, in which the at least one subsequence inside is complemented by an article, by the further step of:
inserting, via the automatic handling machine, the article and a further separating element between two separating elements in the ascertained pair of separating elements such that following the insertion of the article and the further separating element the article is disposed between the further separating element and that separating element in the ascertained pair of separating elements which directly adjoins the at least one subsequence, and the further separating element is disposed between the two separating elements in the ascertained pair of separating elements.

3. The method according to claim 2, wherein the automatic handling machine first inserts the further separating element between the two separating elements in the ascertained pair of separating elements and then inserts the article.

4. The method according to claim 2, which further comprises inserting, via the automatic handling machine, the article between the two separating elements in the ascertained pair of separating elements and then inserts the further separating element.

5. The method according to claim 4, wherein following the insertion of the further separating element and the article, performing the step of:
removing, via the automatic handling machine, from the sequence at least one separating element in that pair of separating elements which is disposed between the inserted further separating element and the at least one subsequence which is complemented by the article to be inserted, the automatic handling machine uses the further separating element and each remaining separating element as a new pair of separating elements which adjoins the at least one subsequence, and uses the separating element which has been removed from the sequence as a further separating element in a subsequent insertion step.

6. The method according to claim 5, which further comprises performing the step of removing one separating element in the pair of separating elements from the sequence as a substep in the subsequent insertion step.

7. The method according to claim 1, wherein at least one sequence is produced such that two adjacent subsequences in the sequence adjoin the same pair of separating elements, and two different separating elements in the pair of separating elements directly adjoin a respective one of the two adjoining subsequences.

8. A sorting installation for sorting articles according to a prescribed feature, the sorting installation comprising:
a data memory storing an order of feature values, which is available to a computer, among possible values of the prescribed feature;
a measuring device configured to take a measurement for each article to determine what value the prescribed feature assumes for the article;
at least one output device;
a plurality of separating elements;
the sorting installation configured to form at least one sequence of articles such that each sequence contains a series of subsequences, all the articles in a subsequence have a same feature value, and an order of the subsequences in the sequence corresponds to a prescribed order of feature values;
the sorting installation configured to repeatedly perform an insertion step and in each insertion step to insert at least one respective article into a sequence such that a subsequence in the sequence, the articles in which all have the same feature value as the article to be inserted, is complemented by the article to be inserted;
the sorting installation configured to perform the insertion steps until each article to be sorted has been inserted into a sequence;
at least one automatic handling machine configured to repeatedly perform an insertion step, and configured to insert a plurality of separating elements into at least one sequence which contains three different subsequences, and to produce the sequence such that each subsequence inside the sequence adjoins a pair containing at least two separating elements, so that one separating element in the pair of separating elements directly adjoins the subsequence, the pair of separating elements separates the subsequence from an adjacent subsequence in the sequence, and following an insertion step there is no article located between the separating elements in the pair of separating elements, and said automatic handling machine further configured to:
perform the following steps for each insertion step, in which a subsequence inside the sequence is complemented by an article;
ascertain a pair of separating elements which adjoins the subsequence and separates the subsequence from an adjoining subsequence; and
insert the article between two separating elements in the ascertained pair of separating elements.
